(19) United States
(12) Patent Application Publication
(10) Pub. No.: US 2006/0156853 A1
(43) Pub. Date: Jul. 20, 2006

(54) Monolithic steering wheel tilt lever

(76) Inventor: Fred Sorensen, Cedar, MI (US)

Correspondence Address: NORTHERN MICHIGAN PATENT LAW, PLC, 526 W. FOURTEENTH ST., #250, TRAVERSE CITY, MI, 49684, US

(21) Appl. No.: 11/026,862

(22) Filed: Dec. 30, 2004

(51) Int. Cl. B62D 1/16

(52) U.S. Cl. 74/492

(57) ABSTRACT

A pivot-mounted tilt lever of the type used with a conventional cam-actuated tilt lock arm in an automotive steering column, the tilt lever being molded as a monolithic body of thermosetting polymer material such as phenolic resin. The tilt lever has a cam release surface for operating the tilt lock arm in the steering column, the cam surface being formed from the thermosetting polymer material as an integrally molded and finished part of the monolithic body. A method for making the tilt lever as a monolithic body is also claimed.

### FIELD OF THE INVENTION

The present invention is in the field of automotive steering wheel column tilt mechanisms.

### DESCRIPTION OF RELATED ART

Many automotive steering wheel columns are tilt-adjustable, with a tilt knob protruding from the column for unlocking and operating a tilt mechanism inside the column. A common type of tilt assembly includes a generally L-shaped pivoting actuator link, often referred to as a rake lever or tilt lever (hereafter “tilt lever”), connected to the exterior tilt knob at one end and to a pivot mount inside the steering column at the other end. The tilt lever has an intermediate cam body on which a metal tilt lock arm or “shoe” rides back and forth between locked and unlocked positions in which it is respectively engaged with and released from a tilt-locking mechanism. The tilt lock arm is typically made from a metal such as steel, and must be forced into its column-locking position by the tilt lever.

Tilt levers of the type used to release such metal tilt lock arms have a metal frame for strength, with a thermoplastic body overmolded onto the metal frame to receive and precisely locate a specially machined metal cam insert. The metal cam insert is formed and finished as a separate piece, and then insert molded into the plastic body as part of a multi-step molding process. The resulting tilt lever is strong and reliable, able to absorb thousands of harsh tilt knob operations while the cam insert reliably operates the lock arm inside the steering column.

Another type of prior tilt lever has a thermoplastic molded body, for example a glass-reinforced nylon, used for a different type of tilt mechanism that does not require the cam actuation of a metal lock arm. It has also been known to insert-mold a metal cam insert into a thermoplastic-bodied tilt lever used with a conventional cam-actuated metal lock arm, but this tilt lever requires a special pivot mount inside the steering column compatible with the relatively soft, creep-prone plastic material.

### BRIEF SUMMARY OF THE INVENTION

The present invention is a pivoting tilt lever of the type used with a conventional cam-actuated metal lock arm. The new tilt lever is lighter, less expensive, and easier to manufacture than prior tilt levers, without sacrificing the reliability and durability needed to operate such a tilt mechanism thousands of times under less than ideal operating conditions.

The new tilt lever has a body molded entirely from a thermosetting plastic material, in the preferred form a phenolic resin, eliminating the metal frame and the metal cam insert and their respective overmolding and insert-molding manufacturing steps. The tilt lever has a first end including or adapted to be connected to an exterior tilt knob, a second end adapted to be mounted to a pivot connection inside the steering column, and an intermediate cam body portion having a cam surface adapted to operate a tilt lock arm. The first and second ends, the cam body and the cam surface are molded as a monolithic piece of thermosetting plastic material, with the cam surface an integral portion of the molded cam body.

The invention is also a method for forming a pivot-mounted tilt lever of this type from a monolithic piece of thermosetting material in a single molding step, with a cam surface adapted to operate the tilt lock arm being formed and finished in the cam body portion during the molding step.

### BRIEF DESCRIPTION OF THE DRAWINGS

FIG. 1 is a perspective view from the lower right side of an automotive steering column with a prior art tilt lever operatively connecting the external tilt knob to an internal tilt lock arm.

FIG. 1A is a detailed perspective view of the prior art tilt lever of FIG. 1, with a thermoplastic overmolded body portion in section view and a metal cam insert exploded from its inserted position in the overmolded plastic portion.

FIG. 2 is similar to FIG. 1, but shows a tilt lever according to the present invention installed in the steering column.

FIG. 2A is a right side elevation view of the tilt lever of FIG. 2 and the metal tilt lock arm in their resting, column-locked positions.

FIG. 2B is similar to FIG. 2A, but shows the tilt lever and lock arm in their unlocked positions.

FIG. 2C is a bottom plan view of FIG. 2.

FIG. 3 is a detailed perspective view of the tilt lever of FIG. 2.

FIG. 4 is a cam-side elevation view of the tilt lever of FIG. 2.

FIG. 5 is a pivot-end perspective view of the tilt lever of FIG. 2.

FIG. 6 is a tilt-knob end view of the tilt lever of FIG. 2.

### DETAILED DESCRIPTION OF THE INVENTION

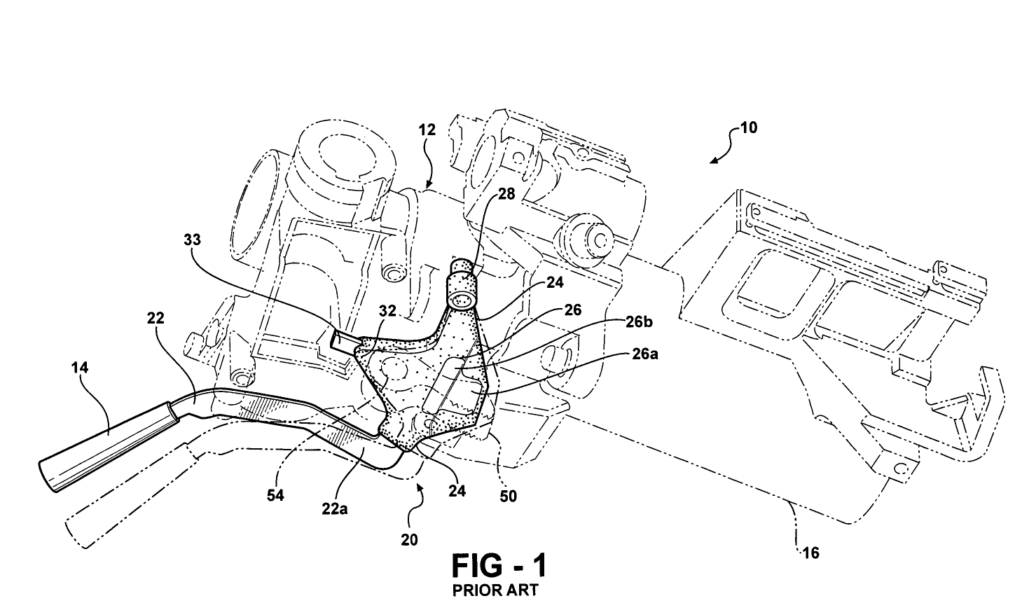

Referring first to FIG. 1, a prior art rake or tilt lever 20 is shown installed in an automotive steering column mechanism 10. Steering column 10 has a tilt-adjustable upper housing 12 capable of tilting, when unlocked or released by tilt knob 14, to a desired angle relative to fixed lower housing 16. The external operation of such tilt columns should be familiar to most automobile drivers, and the internal structure and operation will be familiar to those skilled in the art.

Tilt knob 14 is operatively connected to an arm 22 of a known type of generally L-shaped tilt lever 20 used to release a known type of tilt column lock arm 50. Tilt knob 14 may be a separate piece secured to arm 22, or may be an integral extension of arm 22 with a decorative or cushioning grip or cover as shown. Generally only tilt knob 14 is located outside the steering column, with tilt lever 20 and most or all of its arm 22 hidden from the driver inside the steering column housing.

Tilt lever 20 has a cam release arm or body 24 generally at right angles to at least an inner portion 22a of tilt knob arm 22, although the exact angle between arms 22 and 24 may vary depending on known factors that differ according to tilt column and tilt knob requirements for different vehicles. Tilt knob 14 may even be connected directly to an outer end of cam release portion 24 in certain steering columns. Cam release arm 24 includes a metal cam insert 26 placed and shaped to engage a cam face 52 on the free end of metal tilt lock arm 50. Cam insert 26 has an angled ramp portion 26a whose length and angle determine the degree and amount of cam motion exerted on lock arm 50, and down which the lock arm cam face 52 travels when the steering column is being unlocked; and, a flat 26b on which lock arm cam face 52 rests when the steering column is locked. Tilt lever 20 is biased to its arm-locking position with spring means, for example spring return 32 built into the actuator link. Other spring means acting on lock arm 50 (not shown, but known) and/or the weight of the steering column upper housing acting on lock arm 50 will generally add to the locking bias, tending to hold cam face 52 against flat 26b.

Tilt lever 20 has a pivot connection 28 at the end of cam release arm 24, for example a cylindrical bushing as shown, for pivoting connection to a suitable pivot mount such as a post or socket 40 inside the steering column, allowing tilt lever 20 to pivot through a desired range of motion inside the steering column in response to the driver's operation of tilt knob 14 outside the column. The range of the tilt lever's pivoting motion in the steering column is typically limited by stop surfaces in the column. Stops 30, 32 and 34 positively limit the tilt lever's travel in both directions when they reach such stop surfaces.

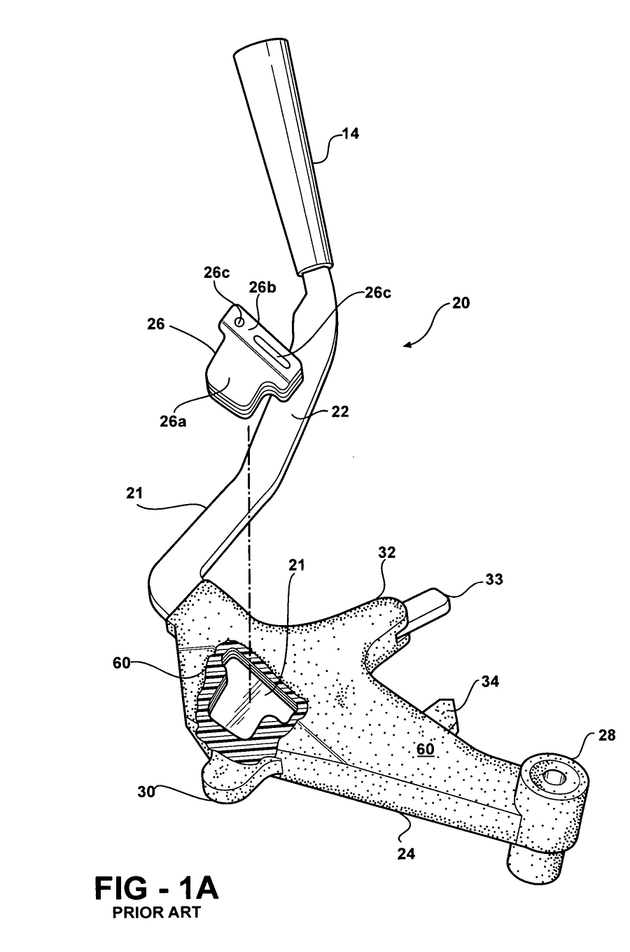

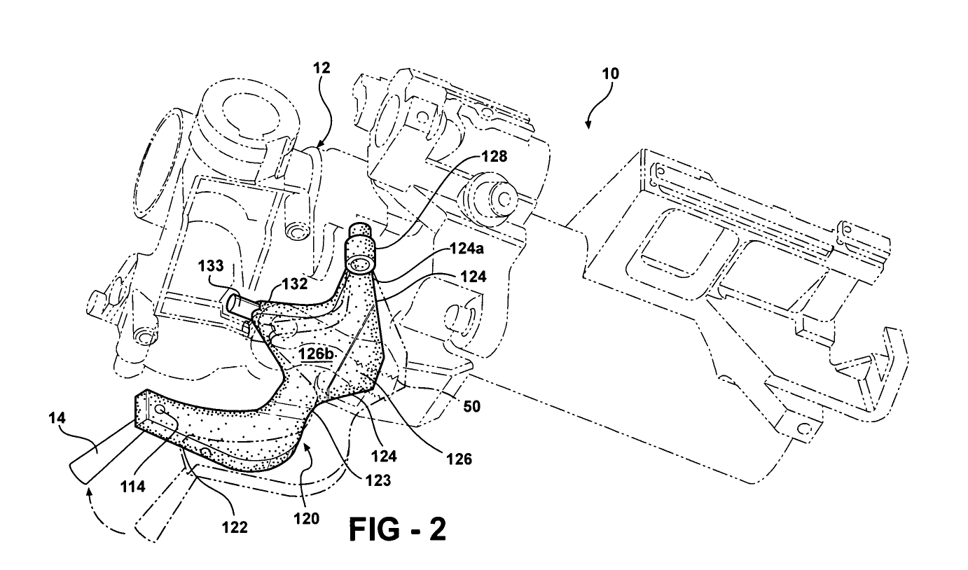

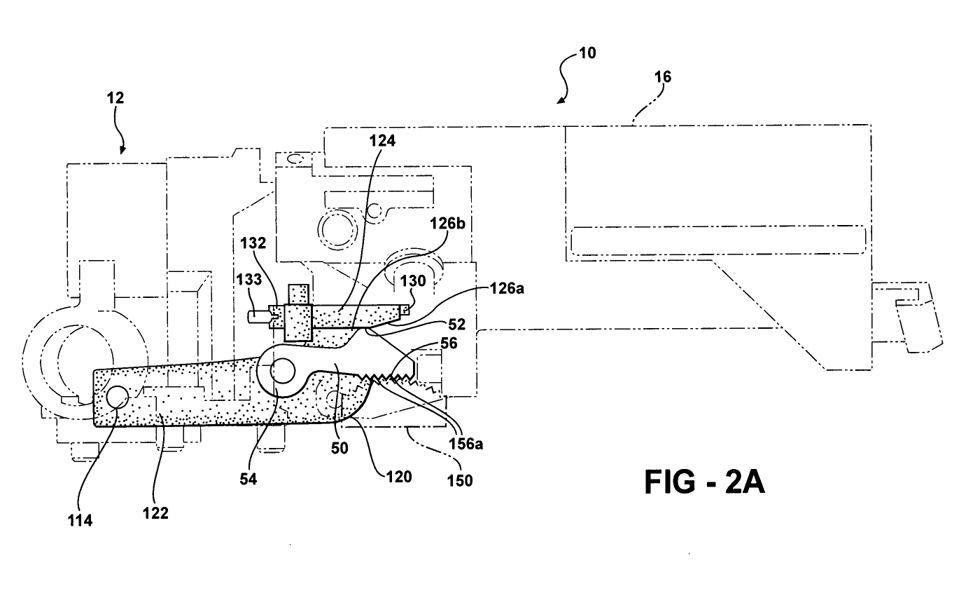

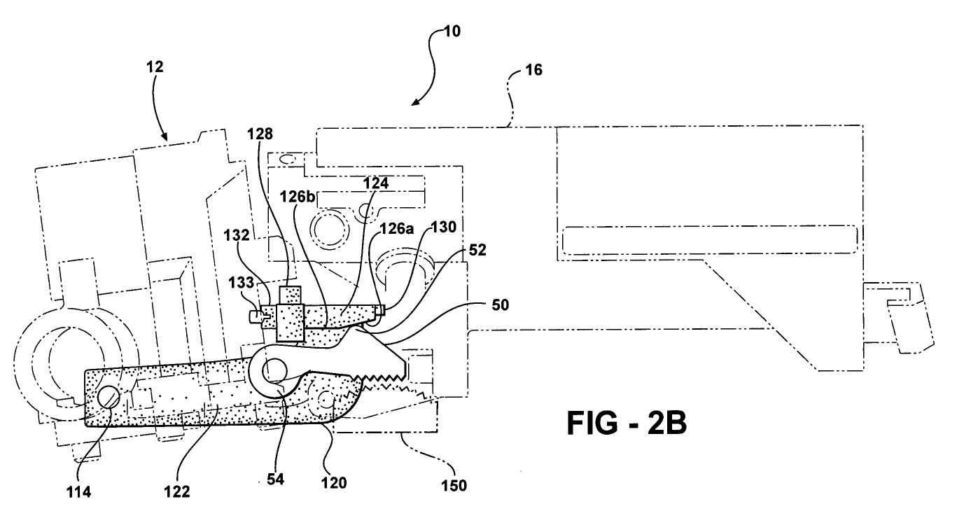

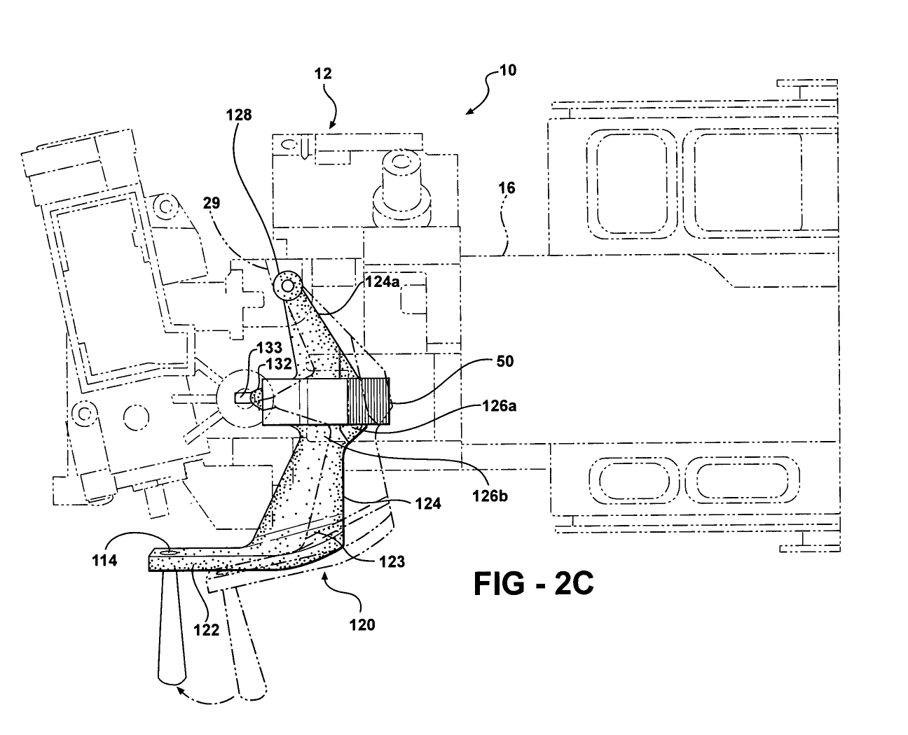

FIG. 1 shows the operative engagement of tilt lever 20 and lock arm 50 in response to the driver's operation of tilt knob 14. Like tilt lever 20, lock arm 50 is also pivotally mounted inside the steering column, for example at bushing 54. In the column-locked position, lock arm 50 is locked against steering column tilt mechanism 150 (see FIG. 2A) by flat 26b of cam insert 26. In the illustrated example, tilt mechanism 150 in the steering column has teeth 156a engaged by lock arm teeth 56. Pulling tilt knob 14 toward the driver moves tilt lever 20, and specifically metal cam insert flat 26b, out of locking engagement with the cam face 52 of lock arm 50, allowing lock arm 50 to move down cam surface ramp 26a and away from its locking engagement with the steering column tilt mechanism 150 in known fashion. The result is that the driver, while keeping the tilt knob pulled back and the lock arm disengaged, can adjust the tilt-adjustable upper housing 12 of the steering column to a desired position. Releasing or returning tilt knob 14 to its original position forces tilt lever 20 back to its rest position shown in broken lines, thereby forcing lock arm cam face 52 back up ramp 26a to its column-locking position on flat 26b.

FIG. 1A illustrates the construction of prior tilt lever 20. Tilt lever 20 is formed in three main pieces or sections: a generally L-shaped metal frame 21 comprising tilt knob connecting arm 22 and the structural support or skeleton of cam release arm 24; a thermoplastic sheath or body 60 molded onto the inner arm of metal frame 21 to define the exterior of cam release arm 24; and the metal cam insert 26. Metal frame 21 is typically made from steel for strength, although other metals or metal alloys might be used. The thermoplastic material of body 60 is typically a nylon or similar thermoplastic, applied with a known molding process such as overmolding. The metal cam insert 26 is typically machined from a suitably wear-resistant steel able to endure thousands of cycles against the metal cam face of lock arm 50. It will be understood by those skilled in the art that cam insert 26 must be precisely machined and finished to provide smooth, reliable operation for the life of the vehicle. Cam insert 26 is typically insert-molded into thermoplastic body 60 using known methods, and has holes 26c formed through flat 26b for handling by tools or positioning pins during its finishing and the overmolding process. The manufacture of tilt lever 20 is accordingly a multi-step process involving several different components and materials.

Referring next to FIGS. 2 through 6, a tilt lever 120 according to the present invention is shown mounted in the steering column in place of the prior art tilt lever 20. Tilt lever 120 operates in identical fashion to lever 20 as described above, and a driver is unlikely to notice any difference in feel or operation, but the structure and manufacturing process for lever 120 are different.

With the exception of spring return pin 133 and its spring, tilt lever 120 is a monolithic piece of molded thermosetting polymer material, in the illustrated embodiment a 60% glass-fiber reinforced phenolic resin of a commercially-available type such as Durez 32633. Illustrated lever 120 is generally L-shaped, with a tilt knob arm 122 incorporating or, as shown in the illustrated embodiment, connected to the external tilt knob 14 at its free end via a threaded mounting connection 114, and a cam release arm or body 124 connected at its outer end 124b to tilt knob arm 122 at a generally right angle through elbow or bight portion 123. Cam release arm 124 includes an integrally molded cam surface 126, which includes an angled ramp release portion 126a and a locking flat 126b. The inner end 124a of cam release arm 124 includes an integrally molded pivot connection or mounting point, in the illustrated embodiment a cylindrical pivot bushing 128 adapted to be pivotally mounted in a pivot mount 29 (FIG. 2C) in the steering column in the same manner as lever 20 in FIG. 1.

Tilt lever 120 also includes integrally molded stops 130, 132, and 134 corresponding to the overmold-formed stops 30, 32, and 34 in FIG. 1. Spring return pin 133 and its spring are mounted in a cavity or bore in stop 32 in essentially the same manner as corresponding return spring structure in FIG. 1.

Cam surface 126 in lever 120 has a smooth, uninterrupted surface formed during the molding operation and requiring no finishing steps beyond those needed to mold lever 120 as a whole. Cam surface 126 is part of a continuous area of molded resin, larger than the area of a typical metal cam insert, without borders or junctions or sharp edges between different materials. Cam surface 126 accordingly provides a surface with a reduced likelihood that surface irregularities, finishing tolerances, handling damage, or lock arm misalignment might cause rough or impaired release and return operations. The glass-fiber reinforced thermosetting phenolic resin is harder than a comparably moldable reinforced thermoplastic, and although not as wear resistant as a metal such as steel, has been found to be sufficiently wear—and damage—resistant for the expected duty cycles in a typical vehicle steering column with a metal lock arm.

Monolithic tilt lever 120 is also lighter and more vibration-resistant than metal-framed, multi-part actuators such as lever 20 shown in FIG. 1.

It will be understood by those skilled in the art that the illustrated tilt lever 120 is representative of a particular model for a particular steering column assembly, and that variations in the relative angle and shape of tilt knob arm 122 and cam release arm 124, the shape and surface area and angle of cam surface 126, the tilt knob and pivot mounting structures 114 and 128, the location and shape of stops, the composition of the thermosetting material, and other features can vary according to the demands of the particular steering column environment without departing from the invention as described via the illustrated example. For example, although a generally L-shaped lever 120 is illustrated in keeping with what seems to be the most common shape in the industry, it will be understood that tilt lever 120 need not be L-shaped or even have a distinct tilt-knob-connecting arm portion 122, with direct connection of a tilt knob to a connector such as 114 at the outer (free) end 124b of cam release portion 124 being possible. In such a case it may be more appropriate to refer to cam release portion 124 as a cam release body, rather than as an arm.

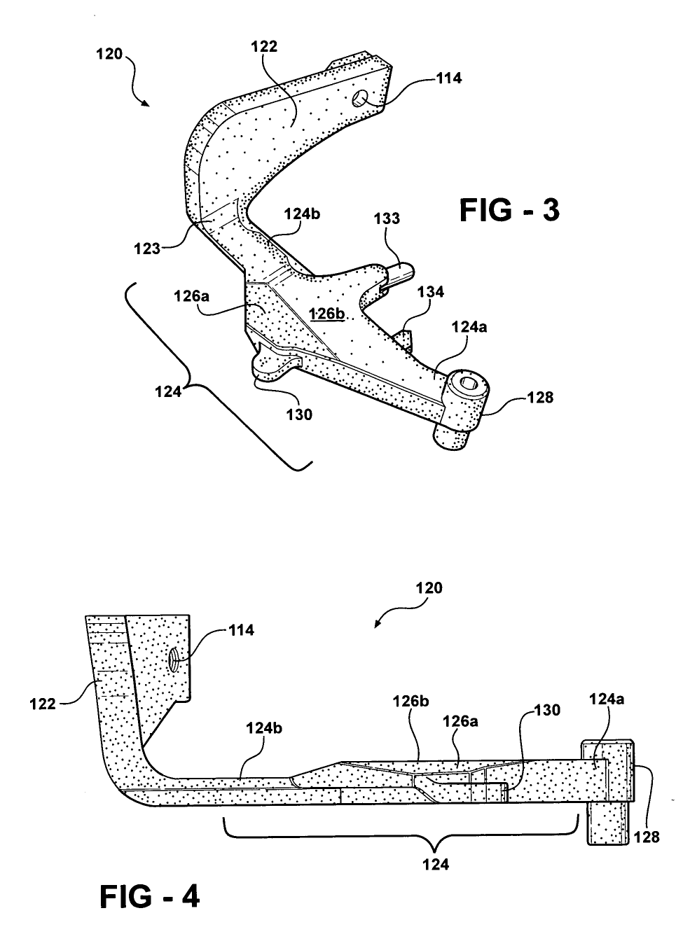

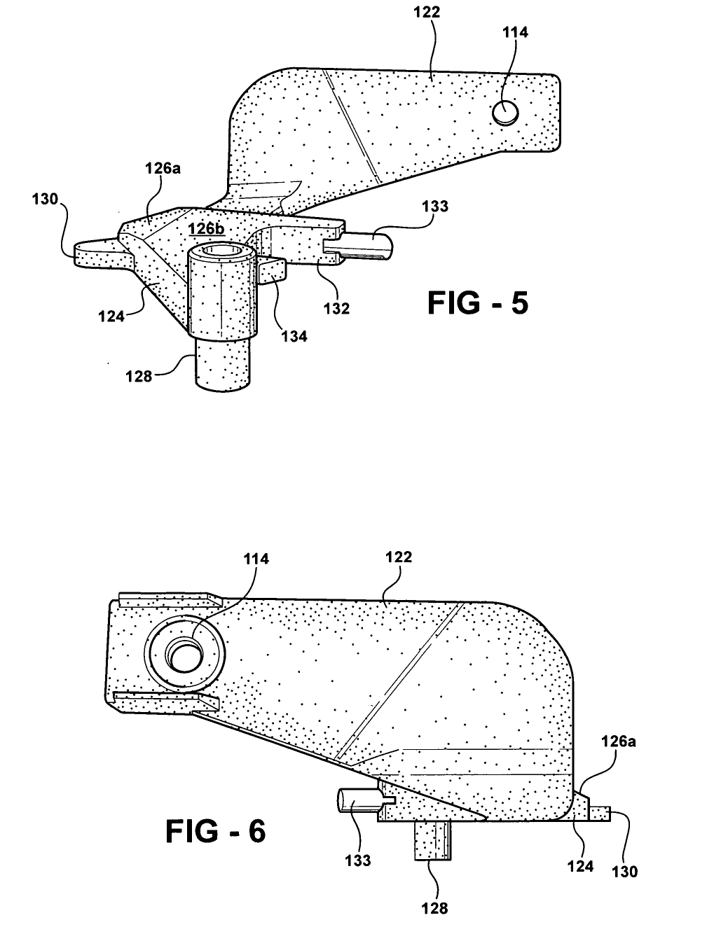

Because thermosetting resins such as phenolic are generally weaker and more brittle than the metal used in prior tilt levers, it will be understood by those skilled in the art that any bend or elbow or tilt knob connection in tilt lever 120 should accordingly have thickness and shape and stress relieving features to withstand the sometimes harsh tilt lever forces likely to be applied. For example, the angle or elbow 123 in the illustrated embodiment is accordingly radiused both inside (FIG. 3) and outside (FIG. 6) for strength.

The manufacturing process for forming actuator link 120 can use known thermosetting molding methods and equipment, for example an injection molding press using mold halves clamped together into a mold while a reciprocating screw in a material processing unit injects a plasticized thermosetting material (e.g., the above-described phenolic resin composite material) into the mold. When the required weight of phenolic composite has been plasticized, the screw rams the plasticized compound through the mold sprue, runners, and gates and into the mold cavity. After a predetermined cure time, the mold is opened and the finished part is ejected. The application of such known molding processes to the manufacture of the tilt lever described above will be apparent to those skilled in the art.

It will finally be understood that the disclosed embodiments are representative of presently preferred forms of the invention, but are intended to be illustrative rather than definitive of the invention. The scope of the invention is defined by the following claims. I accordingly claim:

What is claimed is:

1. A pivot-mounted tilt lever of the type used with a conventional cam-actuated tilt lock arm in an automotive steering column, the tilt lever comprising a first end having or adapted to be connected to a tilt knob, a second end adapted to be connected to a pivot mount in the steering column, and an intermediate cam body portion with a cam surface adapted to operate a tilt lock arm, wherein the first end, the second end, the cam body portion, and the cam surface are formed as a monolithic piece of thermosetting polymer material with the cam surface integrally formed from the thermosetting polymer on the cam body portion.

2. The tilt lever of claim 1, wherein the first end, the second end, the cam body portion, and the cam surface are formed by molding, and the cam surface is a molded surface.

3. The tilt lever of claim 2, wherein the first end, the second end, the cam body portion, and the cam surface are formed during a single molding step, and the cam surface is formed and finished during the single molding step.

4. The tilt lever of claim 1, wherein the actuator link is generally L-shaped, with a tilt knob arm portion and a cam release arm portion generally perpendicular to the tilt knob arm portion, the intermediate cam body and the cam surface being formed on the cam release arm portion.

5. The tilt lever of claim 1, wherein the cam surface comprises a locking flat and an angled release ramp.

6. The tilt lever of claim 6, wherein the locking flat and the angled ramp comprise a continuous surface of the thermosetting polymer material.

7. The tilt lever of claim 7, wherein the continuous surface of the locking flat and angled ramp is continuous with a surface of the intermediate cam body portion.

8. A pivot-mounted tilt lever of the type used with a conventional cam-actuated tilt lock arm in an automotive steering column, the tilt lever being molded as a monolithic body of thermosetting polymer material.

9. The tilt lever of claim 8, wherein the thermosetting polymer is a phenolic resin.

10. The tilt lever of claim 9, wherein the tilt lever has a cam release surface for operating a tilt lock arm in the steering column, the cam surface being formed from the thermosetting polymer material as an integrally molded and finished surface portion of the monolithic body.

11. A method for making a pivot-mounted tilt lever of the type used with a conventional cam-actuated tilt lock arm in an automotive steering column, the tilt lever having a cam portion for slidingly engaging a metal tilt column lock arm, the method comprising the following steps:
molding the tilt lever as a monolithic body of thermosetting polymer material;
forming a cam release surface on the tilt lever from the thermosetting polymer material during the molding step as an integrally molded and finished surface portion of the monolithic body.
